(19) United States
(12) Patent Application Publication
(10) Pub. No.: US 2026/0137063 A1
(43) Pub. Date: May 21, 2026

(54) SYSTEM AND METHOD FOR PROCESSING VIDEO FRAMES DEPICTING AN ANIMAL FOR DETECTION OF HEALTH CONDITIONS EXHIBITED BY THE ANIMAL

(71) Applicant: Companion Professional, Corte Madera, CA (US)

(72) Inventors: Oliver Dain, Courtenay (CA); John Honchariw, Sausalito, CA (US)

(21) Appl. No.: 19/364,546

(22) Filed: Oct. 21, 2025

Related U.S. Application Data
(63) Continuation-in-part of application No. 19/094,459, filed on Mar. 28, 2025.
(60) Provisional application No. 63/572,021, filed on Mar. 29, 2024.
(60) Provisional application No. 63/709,957, filed on Oct. 21, 2024.

(51) Int. Cl. A01K 29/00; G06V 10/62; G06V 10/98; G06V 40/10

(52) U.S. Cl. CPC A01K 29/007; G06V 10/62; G06V 10/993; G06V 40/10

(57) ABSTRACT

One variation of a method includes: during a video capture session for an animal, accessing a video feed captured at a mobile device of a user affiliated with the animal; characterizing quality of a frame of the video feed; and, in response to quality of the frame falling below a threshold quality, generating a prompt to modify a characteristic of video capture and serving the prompt to the mobile device; discarding frames of the video corresponding to quality issues to generate a filtered sequence of frames; assembling the filtered sequence of frames into a sequence of clips; predicting a condition exhibited by the animal based on body data extracted from the sequence of clips; populating a report, describing prediction of the condition, with a subset of clips, in the sequence of clips, correlated with diagnosis of the first condition; and transmitting the report to an animal health professional.

### CROSS-REFERENCE TO RELATED APPLICATIONS

This Application claims the benefit of U.S. Provisional Application No. 63/709,957, filed on 21 Oct. 2024, which is incorporated in its entirety by this reference.

This Application is also a Continuation-In-Part of U.S. patent application Ser. No. 19/094,459, filed on 28 Mar. 2025, which claims the benefit of U.S. Provisional Application No. 63/572,021, filed on 29 Mar. 2024, each of which is incorporated in its entirety by this reference.

### TECHNICAL FIELD

This invention relates generally to the field of veterinary diagnostics and, more specifically, to a new and useful method for video quality assessment and detection of health conditions exhibited by animals in the field of veterinary diagnostics.

### BRIEF DESCRIPTION OF THE FIGURES

FIGS. 1A and 1B are flowchart representations of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

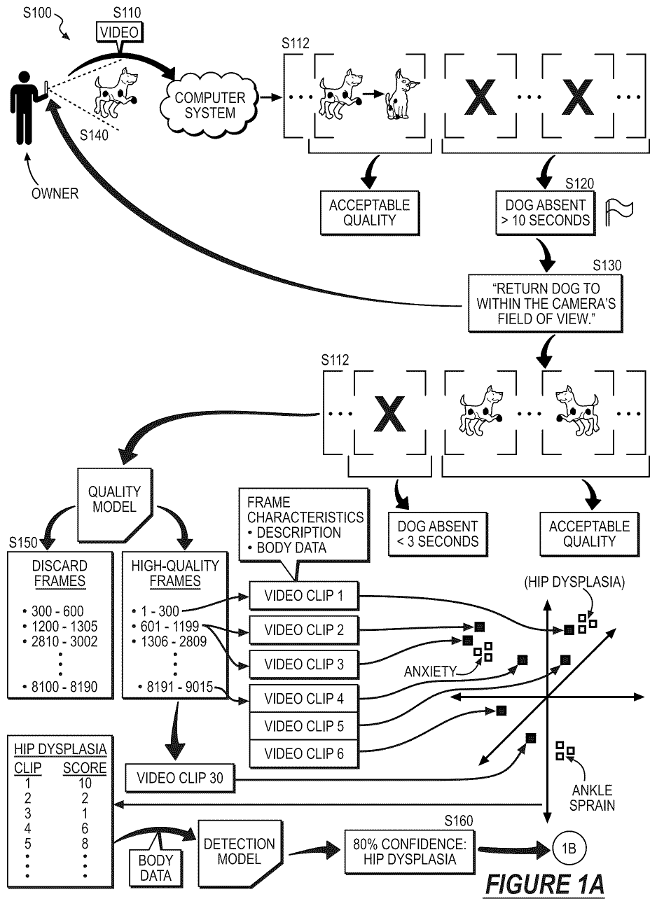

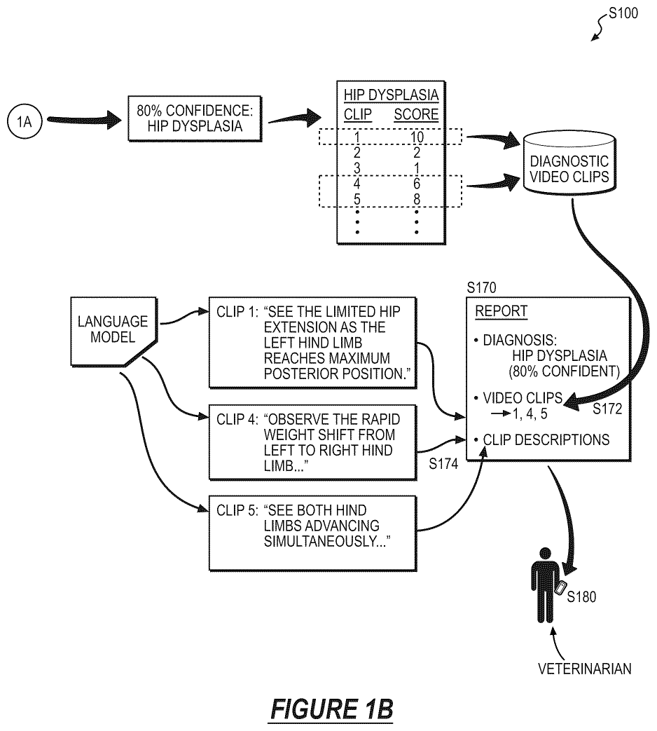

As shown in FIGS. 1A and 1B, a method S100 includes, during a video capture session for an animal: accessing a video feed captured by a camera integrated into a first computing device accessed by a user affiliated with the animal in Block S110; extracting a sequence of frames from the video feed in Block S112; and characterizing a quality of a first frame, in the sequence of frames, based on features extracted from the first frame and a quality model in Block S120. The method S100 further includes, in response to the quality of the first frame falling below a threshold quality: initiating a timer for a fixed duration; characterizing a quality of frames, in the sequence of frames, succeeding the first frame in Block S120; and, in response to the quality of each frame, in the sequence of frames, falling below the threshold quality at expiration of the timer, generating an alert indicating detection of a quality issue and including a prompt to modify a characteristic of video capture in Block S130 and serving the alert to the user during the video capture session in Block S140.

The method S100 further includes, in response to termination of the video capture session: implementing the quality model to identify a subset of frames, in the sequence of frames of the video, corresponding to quality issues; discarding the subset of frames, from the sequence of frames, to generate a filtered sequence of frames representing the video capture session in Block S150; and assembling the filtered sequence of frames into a sequence of video clips based on temporal proximity of the filtered sequence of frames.

The method S100 further includes, implementing a condition model—linking body data (e.g., movement data, pose or posture data, facial expression data) extracted from video clips of animals to a set of conditions (e.g., physiological, neurological) exhibited by animals—to output a set of confidence scores for a set of conditions based on the sequence of video clips, each confidence score representing confidence that the animal exhibits a particular condition in the set of conditions in Block S160. The method S100 further includes, in response to a first confidence score—corresponding to a first condition in the set of conditions—exceeding a threshold confidence: generating a report indicating detection of the first condition for the animal in Block S170; selecting a subset of video clips, in the sequence of video clips, correlated with the first condition and predicted to depict the animal exhibiting the first condition; populating the report with the subset of video clips in Block S172; and transmitting the report to a second computing device accessed by an animal health professional affiliated with the animal in Block S180.

In one variation, as shown in FIG. 1B, the method S100 includes: for each video clip, in the subset of video clips, implementing a language model to generate a text string, in a set of text strings, describing characteristics of the video clip associated with diagnosis of the first condition in Block S174; appending each video clip, in the subset of video clips, with a corresponding text string in the set of text strings output by the language model; and transmitting the report—including the subset of video clips and the set of text strings—to the second computing device in Block S180.

### 2. Applications

Generally, Blocks of the method S100 can be executed by a computer system (e.g., a computer network, a remote computer system, a remote server, a local device) and/or a native application: to access a video of an animal (e.g., a dog, a cat, a horse) captured on a mobile device of an owner of the animal during a video capture session; to provide real-time feedback to the owner during the video capture session to promote capture of high-quality video suitable for diagnostic analysis; to filter frames from the video to identify frames depicting relevant diagnostic information and excluding frames associated with quality issues; to detect instances of various animal conditions—such as including lameness, dermatological conditions, anxiety, neurological conditions, etc.—based on characteristics of the animal extracted from the filtered frames; to identify specific video segments (or “clips”) within the video most relevant to detected instances of medical conditions; and to selectively notify a veterinarian associated with the animal and/or the animal's owner of detected instances of medical conditions.

In particular, the computer system can interface with a native application executing on a mobile device accessed by a user (i.e., the animal's owner) to guide the user through a video capture session with her animal. During the video capture session, the computer system can: access a video feed captured by a camera integrated into the user's mobile device; implement a quality model (e.g., a filter model) to assess quality of individual frames in real-time; and provide immediate feedback to the user when quality issues are detected, such as when the animal moves out of frame, when the animal is too far from the camera, when the animal is exhibiting unnatural movement (e.g., due to leash tugging), or when the animal is not performing requested behaviors.

Therefore, the computer system can: improve quality of videos captured by users during video capture sessions; reduce instances of low-quality videos that require re-recording; minimize time required by users to capture high-quality videos; and enable detection of medical conditions with increased accuracy based on higher-quality video data.

Furthermore, upon completion of the video capture session, the computer system can: implement the quality model to identify and discard frames corresponding to quality issues, such as including frames in which the animal is not detected, frames in which multiple animals are detected, frames in which the animal is too close or too far from the camera, frames in which the animal exhibits unnatural movements, etc.; assemble a sequence of video clips from remaining frames based on temporal proximity of frames of the video; and implement an attention model configured to assign a weight to each video clip based on relevance of the video clip in diagnosing a particular condition based on features extracted from frames of the video clip. The computer system can then predict a confidence in a diagnosis of the particular condition for the animal based on weights assigned to each video clip (e.g., by the attention model) and body data—representing positions, movements, facial features, etc. of the dog and/or of particular body features (e.g., head, feet, knees, hips) of the dog during the video capture session—extracted from frames of each video clip.

In one implementation, the computer system can: rank video clips in descending order based on weights assigned to these video clips; and select a subset of top-ranked video clips (e.g., 3 video clips, 5 video clips) for presentation to the animal's veterinarian in combination with the predicted diagnosis. Therefore, the computer system can: implement the attention model to identify specific video segments within the video that are most diagnostically relevant to a particular condition; and present these video segments to a veterinarian for review, thereby enabling the veterinarian to quickly assess the animal's condition without reviewing an entire video. By surfacing only video clips that most strongly influence prediction of a particular diagnosis (e.g., of a particular condition), the computer system can: enable veterinarians to quickly confirm or disconfirm automated diagnoses by reviewing these specific video clips; reduce cognitive load on veterinarians by eliminating the need to manually scan through entire videos searching for relevant moments; and improve veterinarian trust in automated diagnoses by providing transparency into which video segments support these predicted diagnosis.

The computer system is described below as executing Blocks of the method S100 to selectively filter frames of a video depicting a dog executing a series of postures and/or movements during a video capture session for detection of instances of lameness (e.g., characterized by pain, injury) in these frames. However, the computer system can execute these Blocks of the method in order to selectively filter frames of videos depicting any other type of animal—such as a cat, a horse, or a bird—for detection of instances of lameness in these frames.

Furthermore, the computer system is described below as executing Blocks of the method S100 to notify a veterinarian—affiliated with an animal—of detection of lameness of a particular lameness type for the animal. However, the computer system can execute these Blocks of the method in order to notify any other type of animal health professional—such as a veterinary technician or technologist, an animal nutritionist, an animal physiotherapist, an animal behaviorist or trainer, etc.—of detection of lameness of a particular lameness type for the animal.

### 3. Application+Onboarding

Generally, the computer system can interface with a native application or web application executing on a computing device accessed by a user (e.g., a pet owner) affiliated with a dog. In one implementation, the computer system can prompt the user to generate a dog profile for her dog within the native application. For example, the user may download a native application to her smartphone or navigate to a web application within a browser executing on her smartphone. The computer system can then: generate a prompt to create a dog profile for her dog within the application and manually populate the dog profile with various information, such as a name, breed, age, size (e.g., weight, height, length), and/or primary coat colors of her dog; and transmit the prompt to the user via the application. The computer system can then: receive this information from the user via the application; and store the dog profile—populated with the dog's information—in a remote database.

Additionally or alternatively, in another example, the computer system can automatically populate the dog profile with dog characteristics extracted from an image or video of the dog recorded by the user. For example, in response to the user downloading the native application to her smartphone, the computer system can: generate a prompt to capture a video of the dog via a camera integrated in the user's smartphone; transmit the prompt to the user; in response to receiving the video, derive a set of dog characteristics—such as including a breed, a size, a set of primary coat colors of the dog's coat, etc.—of the dog based on features extracted from frames of the video; and populate a dog profile—generated for the dog—with the set of dog characteristics.

In one implementation, the computer system can: transmit prompts to the user and receive videos from the user via an instance of an owner portal—executing on a computing device accessed by the user (e.g., within the application)—associated with the user; and/or transmit prompts, reports, and/or videos of the animal to an animal health professional (e.g., a veterinarian), affiliated with the animal, via an instance of a veterinarian portal—executing on a computing device accessed by the animal health professional—associated with the animal health professional. In this implementation, the computer system can thus enable communication and/or sharing of data (e.g., video) between the owner and veterinarian portals.

Additionally and/or alternatively, in one implementation, the computer system can interface with a patient management system (e.g., a cloud platform) employed by an animal health professional and/or animal health network. In this implementation, the computer system can both transmit prompts, reports, and/or videos of the animal to an animal health professional, and receive requests for video and/or other communications from the animal health professional via the patient management system. The computer system can therefore enable the animal health professional to access this information (e.g., reports, videos)—and/or request information—regarding an animal directly within the patient management system already implemented by the animal health professional, rather than requiring the animal health professional to access an additional external tool or application.

### 4. Video Capture Session

Generally, once the computer system has accessed the foregoing data, the computer system can prompt the user (i.e., the dog owner) to initiate a video capture session for the dog. In particular, the computer system can: generate a prompt to locate the dog within a particular space—co-occupied by the user—in preparation for a video capture session; and transmit the prompt to the user (e.g., via push notification, via text message). For example, the computer system can transmit the prompt to the user via an instance of an owner portal executing on a computing device (e.g., a smartphone, a tablet, a desktop computer) accessed by the user.

Then, in response to receiving confirmation from the user that the dog is located in the particular space (e.g., with the user) and that the user is ready to begin a video capture session, the computer system can generate one or more prompts to: locate the dog within a field of view of a camera integrated into the user's mobile device; initiate a video recording of the dog within the field of view at a start of the video capture session; and promote (e.g., via voice command) execution of a series of movements by the dog—within the field of view of the camera—during the video capture session.

In one implementation, the computer system can prompt the user to capture a video recording of the dog executing a series of poses and/or movements according to a video session protocol configured to highlight pain, injury, illness, etc. experienced by the dog. For example, prior to a video capture session, the computer system can load a video session protocol locally onto the application for execution with the dog and/or the user during the video capture session. In this example, the computer system can select a video session protocol configured to enable evaluation of the dog's postures and/or movements during a set of transition poses (e.g., “stand to sit” transition pose, “sit to down” transition pose, “down to stand” transition pose) and/or and the dog's gait (e.g., posture, velocity, stride length, balance, weight distribution, duration) while walking.

In particular, in one example, the computer system can prompt the user to capture video of the dog: from a rear-facing view with the dog walking directly away from the camera in a first direction; from a frontward-facing view with the dog walking directly toward the camera in a second direction opposite the first direction; in a first side-facing view with the dog walking in a third direction and oriented approximately 90-degrees from the camera; in a second-side facing view with the dog walking a fourth direction—opposite the third direction—and oriented approximately 90-degrees from the camera; etc. The computer system can also prompt the user to capture video of the dog: from the frontward-facing view with the dog transitioning from a “sit” position to a “stand” position; from the first and/or second side-facing view with the dog transitioning from the “sit” position to the “stand” position; from the frontward-facing view with the dog transitioning from the “stand” position to a “lie-down” position; from the first and/or second side-facing view with the dog transitioning from the “stand” position to the “lie-down” position; etc.

In another example, to evaluate a dermatological condition detection during a video capture session, the computer system can prompt the user to: locate a specific body part of the animal within the field of view of the camera; manually spread fur on the animal to expose skin; position the camera at a close distance from the body part; and maintain the camera in a stable position for a minimum duration.

### 5. Video Quality Assessment

Generally, the computer system can characterize quality of frames of a video captured by the user during the video capture session.

In one implementation, the computer system can implement a quality model (e.g., a filter model) configured to characterize quality of individual frames captured during a video capture session (e.g., in real-time or post-hoc). In particular, the computer system can implement the quality model to detect various quality issues - depicted in frames of a video captured during the video capture session - such as including: absence of the animal from a frame; presence of multiple animals in the frame; the animal positioned at a distance exceeding a maximum distance from a camera integrated in the owner's mobile device (e.g., capturing the video); the animal positioned at a distance less than a minimum distance from the camera; the animal exhibiting unnatural movement, such as due to leash tugging or owner manipulation; the animal exhibiting excited or playful behavior incompatible with diagnostic analysis; occlusion of relevant body features (e.g., hind legs, head, tail) by objects in the working field (e.g., furniture, walls, humans); poor lighting; excessive motion blur; failure of the animal to perform target behaviors; etc.

In one example, for a first frame in a sequence of frames of a video captured during the video captured session, the computer system can implement the quality model to: define a bounding box containing the animal within the first frame; calculate a first size of the bounding box; calculate a ratio of the first size of the bounding box to a second size of the first frame; and characterize quality of the first frame based on the first ratio. In particular, in one example, the computer system can: characterize quality of the frame as “low” in response to the first ratio—of the first size of the bounding box to the second size of the first frame—falling below a lower ratio threshold and thus indicating the animal is too far from the camera; characterize quality of the frame as “low” in response to the first ratio exceeding an upper ratio threshold and thus indicating the animal is too close to the camera; and characterize quality of the frame as “acceptable” in response to the first ratio falling within a target ratio range interposed between the lower ratio threshold and the upper ratio threshold. The computer system can then repeat this process for each frame, in the sequence of frames, to characterize each frame as “low” quality or “acceptable” quality accordingly.

In another example, the computer system can implement the quality model (e.g., a deep neural network) to detect instances of “unnatural” movements—incompatible with detection of possible animal conditions (e.g., lameness, anxiety, neurological disorders, physiological disorders)—executed by the animal, such as including the animal lying on their back, the animal chasing a ball or playing with a toy, the animal tugging their leash, etc. In particular, in one example, the computer system can: extract a set of motion vectors representing movement of the animal within the working field as depicted between consecutive frames in a first subsequence of frames of the video; implement the quality model to characterize motion of the animal as a particular movement type in a set of movement types—such as including natural gait, leash tugging, excited behavior, and/or other movement types—based on the set of motion vectors; and characterize quality of each frame, in the first subsequence of frames, based on the particular movement type. For example, the computer system can characterize quality of the frame as “low” in response to detecting leash tugging or excited behavior, and characterize quality of the frame as “acceptable” in response to detecting natural gait.

### 5.1 Real-time Video Quality Assessment

The computer system can implement the quality model in real-time and at the owner's mobile device in order to: detect quality issues in real-time during video capture; and alert the owner of detected quality issues in real-time.

In particular, the computer system can derive insights with higher resolution and/or increased accuracy from videos of relatively higher quality. Therefore, the computer system can alert the owner of detected quality issues in near real-time in order to enable correction of quality issues and thus avoid further analysis of low-quality video and/or avoid requiring the owner to execute an additional video capture session.

### 5.1.1 Real-time Owner Feedback: Visual Feedback

In one implementation, the computer system can provide real-time visual feedback to the user during the video capture session by rendering visual indicators on a display of the mobile device.

For example, the computer system can: render a rectangular outline on the display during recording of the video; and prompt the user to locate the animal within the rectangular outline, such that the animal remains within a target region of the field of view and at a target distance from the camera. Furthermore, in this example, the computer system can modify a color or appearance of the rectangular outline to provide feedback regarding whether the animal is properly positioned within the field of view. For example, the computer system can: render a red rectangular outline in response to detecting that the animal is located outside the target region defined by the rectangular outline; render a yellow rectangular outline in response to detecting that a portion of the animal is located outside the target region; and render a green rectangular outline in response to detecting that the animal is located entirely within the target region.

In another implementation, the computer system can render text-based prompts on the display to provide instructions to the user. For example, the computer system can render prompts such as: “Move closer to your dog”; “Step back from your dog”; “Center your dog in the frame”; “Reduce tension on the leash”; “Ask your dog to sit”; etc.

In yet another implementation, the computer system can render visual indicators highlighting particular objects and/or occlusions detected in the video feed. For example, the computer system can: detect that the animal's legs are occluded by a piece of furniture; render a visual indicator (e.g., a highlighted region, an arrow) on the display indicating the occluding object; and render a prompt to reposition the animal or the camera in order to locate the animal's legs in the field of view.

### 5.1.2 Real-time Owner Feedback: Audible Feedback

Additionally or alternatively, in one implementation, the computer system can provide real-time audible feedback to the user during the video capture session by outputting audio via a speaker integrated in the owner's mobile device while capturing the video. For example, the computer system can output audible instructions such as: “Your dog is out of frame, please reposition your camera”; “Your dog is too far away, please move closer”; “Please reduce tension on the leash”; “Great job, keep going”; etc.

In this implementation, the computer system can prioritize audible feedback over visual feedback responsive to predicting that the owner is unlikely to be looking at the mobile device display (e.g., during the video capture session). For example, the user may: position their mobile device to locate the working field within a field of view of the camera integrated with the mobile device; and walk with their animal back and forth in front of the camera. In this example, the computer system can: detect presence of the owner in frames of the video in (near) real time; and automatically output audible feedback—as needed—rather than visual feedback that the owner is unlikely to view.

5.1.3 Real-time Owner Feedback: Transient vs. Persistent Quality Issues

In one implementation, the computer system can: characterize a detected quality issue as transient or persistent; and selectively notify the owner in real-time of the detected quality issue based on whether the detected quality issue is transient or persistent. In particular, the computer system can distinguish between transient quality issues—which resolve quickly and do not require user intervention to resolve—and persistent quality issues—which may require user intervention to resolve.

In one example, the computer system can: track a duration of a detected quality issue spanning multiple consecutive frames of the video; and, in response to the duration of the quality issue falling below a threshold duration (e.g., 3 seconds, 5 seconds), characterize the quality issue as transient and withhold alerting of the owner (e.g., via audible or visual feedback) regarding the quality issue. Alternatively, in response to the duration of the quality issue exceeding the threshold duration, the computer system can: characterize the quality issue as persistent; generate an alert (e.g., a visual or audible alert) indicating detection of the quality issue and/or including an action to mitigate the quality issue; and transmit the alert to the owner in (near) real time.

In another example, the computer system can: at a first time, detect an out-of-frame condition corresponding to the animal moving out of frame of the camera; initiate a timer for a fixed duration (e.g., 3 seconds, 5 seconds) at the first time; continue monitoring subsequent frames to track whether the animal returns to the frame; and, in response to detecting that the animal has returned within frame prior to expiration of the timer, characterize the out-of-frame condition as transient and thus refrain from transmitting real-time feedback to the owner. Alternatively, in response to detecting that the animal has not returned to the frame within 5 seconds of the first time, the computer system can: classify the out-of-frame condition as persistent; generate a prompt to reposition the camera to include the animal within the frame; and transmit the prompt to the user.

Therefore, computer system can leverage distinction between transient and persistent quality issues to: avoid overwhelming the owner with excessive feedback for quality issues that may resolve without user intervention; prevent owner frustration and/or confusion due to rapidly-changing feedback; and improve accuracy of feedback provided to the owner by filtering out false-positive quality issues that briefly appear, such as due to natural animal movement, transient environmental factors, etc.

### 5.2 Post-capture Video Quality Assessment & Owner Feedback

Additionally or alternatively, the computer system can implement the quality model upon completion of the video capture session. In particular, upon completion of recording the video during the video capture session, the computer system can: access the video; implement the quality model to characterize quality of all frames in the video; identify segments of the video that exhibit quality issues; characterize an overall quality of the video based on detected quality issues; and selectively provide feedback to the owner based on the overall quality of the video.

For example, the computer system can: implement the quality model to identify that a first segment of the video—corresponding to a “sit to stand” transition—exhibits occlusion of the animal's hind legs by a foreign object (e.g., furniture) located within the field of view of the camera; generate a prompt indicating a quality issue in the first segment of the video and requesting re-recording of the “sit to stand” transition; and transmit the prompt to the owner. The computer system can then: receive a second video from the owner depicting only the “sit to stand” transition; append the first video with the second video to generate a complete video; and proceed with analysis of the complete video (as further described below).

### 5.3 Quality Assessment & Frame Selection for Condition Detection

Upon completion of the video capture session, the computer system can implement the quality model (e.g., a filter model) to select a subset of frames, in a sequence of frames, of the video for analyzing for condition detection for the animal. In particular, the computer system can discard frames, in the sequence of frames, exhibiting quality issues and leverage remaining frames for condition detection.

In one implementation, the computer system can implement the quality model to: identify and discard frames in which the animal is not detected; identify and discard frames in which multiple animals are detected; identify and discard frames in which a size of the bounding box (e.g., as described above) falls outside a target size range; identify and discard frames in which the animal exhibits unnatural movements or behaviors; etc. Therefore, the computer system can discard these frames—not compatible with condition detection and/or predicted to hinder accurate condition detection—rather than implement these frames during condition detection, thereby: improving accuracy of condition detection; minimizing an amount of storage required for storing frames of the video; minimize compute required to analyze frames of the video for condition detection; and thus minimize latency in analyzing frames of the video for condition detection.

### 6. Condition Detection & Clip Selection

Generally, the computer system can leverage a condition model—linking features depicted in frames of the video to various conditions of animals (e.g., physical conditions, neurological conditions)—to predict whether an animal exhibits a particular condition.

For example, the computer system can input a sequence of frames of the video—captured during the video session with the animal—into the condition model (e.g., a deep neural network) to generate: a first score representing a likelihood that the animal exhibits a first condition (e.g., hip dysplasia); a second score representing a likelihood that the animal exhibits a second condition (e.g., arthritis); a third score representing a likelihood that the animal exhibits a second condition (e.g., anxiety); etc. In this example, the computer system can repeat this process to: generate a score for each condition, in a set of conditions, defined for a particular animal type (e.g., dog, cat, horse); and predict whether the animal exhibits the condition based on the score for this condition. In particular, in this example, in response to the first score exceeding a first threshold defined for the first condition, the computer system can predict that the animal exhibits the first condition. Alternatively, in response to the second score falling below a second threshold defined for the second condition, the computer system can predict that the animal does not exhibit the second condition.

In one implementation, the computer system can: extract a set of body data—representing positions, movements, facial features, etc. of the dog and/or of particular body features (e.g., head, feet, knees, hips) of the dog during the video capture session—from frames of the video; and implement the condition model—linking characteristics of dog movements, postures, and/or expressions (e.g., facial expressions) to various conditions of animals, such as including a sprain, a fracture, dysplasia, arthritis, cancer, broken or overgrown toenails, anxiety, a neurological disorder, etc.—to predict whether the animal exhibits a particular condition.

Additionally or alternatively, in one implementation, the computer system can selectively weight segments (or “clips) of the video to predict whether the animal exhibits a particular condition based on relevance of each segment to the particular condition. For example, in evaluating whether a dog exhibits a rear-left ankle sprain, the computer system can: assign a first weight (e.g., “100%”) to segments of the video depicting the dog walking with the rear-left leg directly in frame and within a threshold distance of the camera; assign a second weight (e.g., “50%”)—less than the first weight—to segments of the video depicting the dog walking with the rear-left leg directly in frame and outside the threshold distance of the camera; and assign a third weight (e.g., “0%)—less than the second weight—to segments of the video with the rear-left leg out of frame. Therefore, rather than evaluating all frames of the video equally for each condition, the computer system can predict whether an animal exhibits a particular condition based on video segments most-relevant to the particular condition.

### 6.1 Clip Embeddings+Diagnostic Predictions

In one variation, the computer system: generates a set of clip embeddings representing characteristics of video clips extracted from the video; projects the set of clip embeddings into a multi-dimensional feature space (e.g., a vector space); and selectively predicts whether the animal exhibits a set of conditions based on proximity of the set of clip embeddings to clusters of template embeddings—representing characteristics of video clips known to depict animals exhibiting the set of conditions—within the multi-dimensional feature space.

For example, for a first frame in a sequence of frames of the video, the computer system can: extract a first set of frame characteristics—including body data, visual characteristics, audible characteristics, etc.—from the first frame; and represent the first set of frame characteristics in a first frame vector representative of the first frame. The computer system can then combine the first frame vector with other frame vectors generated for frames temporally adjacent the first frame, in the sequence of frames, to generate a first clip vector representative of a first clip of the video including the first frame. The computer system can then: project the first clip vector into a vector space populated with clusters of template vector clusters, each cluster of template vectors representing a particular condition (e.g., lameness of a particular type, anxiety, pain) exhibited by animals; and calculate a first similarity score, in a first set of similarity scores, between the first clip vector and a first cluster of template vectors—representing a first condition exhibited by animals—based on proximity of clip vector to template vectors in the first cluster of template vectors within the vector space. The computer system can repeat this process to calculate the first set of similarity scores—including similarity scores for the set of conditions—based on proximity of the first clip vector to each cluster of template vectors within the vector space. Furthermore, the computer system can repeat this process to: generate a vector for each frame in the sequence of frames of the video; and calculate a set of similarity scores—including similarity scores for the set of conditions—for each vector based on proximity of clip vector to each cluster of template vectors within the vector space.

Then, for a particular condition, in the set of conditions, represented by a particular cluster of template vectors in the vector space, the computer system can: normalize a subset of similarity scores representing proximity between each clip vector and the particular cluster of template vectors—to generate a subset of normalized similarity scores; and assign a set of weights—corresponding to the subset of normalized similarity scores—to each video clip of the video for detection of this particular condition. Based on the set of weights and body data—representing positions, movements, facial features, etc. of the dog and/or of particular body features (e.g., head, feet, knees, hips) of the dog during the video capture session extracted from each video clip, the computer system can predict whether the animal exhibits the particular condition. Therefore, to predict whether the animal exhibits this particular condition, the computer system can more heavily weight characteristics and/or features extracted from video clips associated with higher similarity scores—for this particular condition—and less heavily weight characteristics and/or features extracted from video clips associated with lower similarity scores, and thereby depicting less relevant diagnostic information for this particular condition.

Furthermore, the computer system can thus: generate compact representations of diagnostic information contained in temporal segments (or “clips”) of the video; enable efficient processing of high-duration videos by reducing memory requirements; and enable identification and prioritization of the most diagnostically-relevant segments of the video.

### 7. Veterinarian Report

Generally, the computer system can generate a report—indicating detection of various conditions for the animal—for review by a veterinarian (or other animal healthcare professional) associated with the animal.

In particular, the computer system can: generate a report summarizing any instances of animal conditions detected in the video and/or including particular frames or clips of the video depicting these instances of animal conditions; generate a prompt to review the report and/or the (original) video or clips recorded during the video capture session; and transmit the prompt—including the report and the video—to the veterinarian via a veterinarian portal. Therefore, the computer system can automatically surface instances of conditions detected within the video—including clips and/or images supporting prediction of these instances of these conditions—to the veterinarian for review, thereby enabling the veterinarian to more quickly confirm and/or disconfirm instances of various conditions exhibited by the animal.

### 7.1.1 Diagnostic Video Clips

The computer system can append the report with a set of video clips most relevant to a particular condition exhibited by the animal during execution of the video capture session. For example, in response to predicting that the animal exhibits lameness in the left hind limb, the computer system can generate a report including: a notification stating “Moderate lameness detected in left hind limb”; a set of 4 video clips highlighting lameness in the left hind limb of the animal; and a prompt stating “Please review these video clips for signs of lameness.”

In one implementation, the computer system can: score each video clip—derived from the video captured during the video capture session—based on relevance of contents of the video clip to a particular condition and/or whether the animal exhibits the particular condition in the video clip (e.g., as described above); identify a subset of video clips corresponding to scores above a threshold score and exceeding all other scores of other video clips in the video; and append the report with this subset of video clips. Therefore, the computer system can select video clips that exhibit scores: above a minimum score, such that each video clip selected is highly-relevant to the particular condition; and ranking higher than other video clips (e.g., with scores above the minimum score), thereby ensuring the most-relevant video clips are selected and served to the veterinarian for review.

Therefore, the computer system enables the veterinarian to quickly assess whether the animal exhibits the particular condition in this relatively small subset of selected video clips, without requiring the veterinarian to review an entire video and/or a high quantity of video clips.

### 7.2 Language Model: Description of Diagnostic Video Segments

In one variation, the computer system can implement a language model (e.g., a large language model) to generate natural-language descriptions of predicted instances of various health conditions for presentation to veterinarians and/or animal owners.

In one implementation, the computer system can access a language model trained on veterinary medical texts and annotated videos of animals exhibiting medical conditions. Then, for each video segment (or “clip”) in a set of selected video segments, the computer system can: input the video segment and associated body data into the language model; prompt the language model to generate a description of observable characteristics—depicting and/or associated with the medical condition—depicted in the video segment; and receive a text string—output by the language model—describing observable characteristics depicted in the video segment and associated with the medical condition.

For example, for a video segment depicting a dog walking with lameness, the computer system can: input the video segment and extracted body data—indicating reduced weight bearing on the left hind limb—into the language model; and receive a text string stating “In this clip, the left hind limb appears stiff during the stance phase of gait, with reduced flexion of the stifle joint. The dog exhibits shortened stride length on the affected limb and shifts weight toward the right side to compensate.” The computer system can then: generate a veterinarian report including the video segment; append the veterinarian report with the text string describing features of the video segment depicting the (predicted) condition exhibited by the dog; and present the veterinarian report to the veterinarian, thereby enabling the veterinarian to quickly understand specific characteristics of the detected medical condition—depicted in the video segment—without requiring detailed analysis of the video by the veterinarian.

### 7.2.1 Training the Language Model

In one implementation, the computer system can train the language model on a set of training data including: a corpus of videos (e.g., thousands, hundreds of thousands) of animals exhibiting various medical conditions; annotations of each video describing specific characteristics of medical conditions detectable in the video; corresponding body data extracted from each video; veterinary medical texts describing diagnostic criteria for various medical conditions; etc. The computer system can thus train the language model to generate text strings that: accurately describe observable characteristics of medical conditions; include appropriate veterinary terminology; and highlight particular body features and movements relevant to a diagnosis and/or these medical conditions.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a video capture session for an animal:
accessing a video feed captured by a camera integrated into a first computing device accessed by a user affiliated with the animal;
extracting a sequence of frames from the video feed;
characterizing a quality of a first subset of frames, in the sequence of
frames, based on features extracted from the first frame and a quality model; and
in response to the quality of the first subset of frames falling below a threshold quality:
initiating a timer for a fixed duration;
characterizing a quality of frames, in the sequence of frames, succeeding the first frame; and
in response to the quality of each frame, in the sequence of frames, falling below the threshold quality at expiration of the timer:
generating an alert indicating detection of a quality issue and including a prompt to modify a characteristic of video capture; and
serving the alert to the user during the video capture
session;
in response to termination of the video capture session:
implementing the quality model to identify a subset of frames, in the sequence of frames of the video, corresponding to quality issues;
discarding the subset of frames, from the sequence of frames, to generate a filtered sequence of frames representing the video capture session; and
assembling the filtered sequence of frames into a sequence of video clips based on temporal proximity of the filtered sequence of frames;
accessing a condition model linking features extracted from video clips of animals to a set of conditions exhibited by animals;
based on the condition model and the sequence of video clips, predicting a first confidence score for a first diagnosis of a first condition, in the set of conditions, for the animal; and
in response to the first confidence score exceeding a threshold confidence score:
generating a report indicating detection of the first condition for the animal;
populating the report with a subset of video clips, in the sequence of video clips, associated with detection of the first condition for the animal; and
transmitting the report to a second computing device accessed by an animal health professional affiliated with the animal.

2. The method of claim 1, further comprising:
implementing a language model to generate a text string, in a set of text strings, describing characteristics of the first video clip associated with diagnosis of the first condition; and
appending the first video clip, in the subset of video clips, with the text string.
